(19) United States
(12) Patent Application Publication
(10) Pub. No.: US 2009/0251412 A1
(43) Pub. Date: Oct. 8, 2009

(54) MOTION SENSING INPUT DEVICE OF COMPUTER SYSTEM

(76) Inventor: Tian-Kai Chang, Taipei (TW)

Correspondence Address: Dr. BANGER SHIA;Int''l Patent Office of Bang Shia, 102 Lindencrest Ct, Sugar Land, TX, 77479-5201, US

(21) Appl. No.: 12/464,190

(22) Filed: May 12, 2009

(30) Foreign Application Priority Data
Apr. 7, 2008 (TW) 97125161

(51) Int. Cl. G09G 5/08

(52) U.S. Cl. 345/158

(57) ABSTRACT

A motion sensing input device of a computer system includes a motion sensor and a receiver. The motion sensor has two gyroscopes for sensing motions in different directions when a user operates the motion sensor. The motion signals are wirelessly transmitted to the receiver connected with the computer system. Furthermore, the motion signals are directly decoded via the receiver, and then they are converted to keyboard input signals. When the user plays a computer game by using the motion sensor to replace a keyboard, the user can experience a lifelike game environment and an intuitive operation mode.

### BACKGROUND OF THE INVENTION

1. Field of the Invention

The invention relates to an input device used at a computer system and, more particularly, to a motion sensing input device of a computer system capable of sensing operation motions of a user and replacing a keyboard.

2. Description of the Related Art

A computer system is not only used to process words during general work, but it is also an entertainment tool for a general user. Besides video entertainment, the computer system also plays an important role in playing computer games. The most basic input devices of the computer system are a keyboard and a mouse. As far as general computer games, the keyboard and the mouse are sufficient to play the computer games. However, to satisfy players pursuing a better operation custom and an entertainment effect, a universal joystick similar to a TV video game or an operator such as a steering wheel used in a specific game is released to be used at the computer system.

The Wii is a next generation video game console of Nintendo. After the Wii is released, it sets off a rush across the globe from North American, Japan, and Oceania to Europe. The main body software has a hot sale. The Wii adopts unique proprioception play to provide lifelike game contents for the players. At the same time, the proprioception play not only discards unhealthy notions about the games, but it also provides entertainment leisure and sport leisure for modern people.

Besides in the TV video games, the proprioception play is also popular in computer systems and in other electronic devices. For example, U.S. Pat. No. 7,239,301 discloses a mouse having a built-in sensor. The motions of a user to operate the mouse can directly correspond to different kinds of movements of a cursor. The movements include shift, rotation, and so on. U.S. Pat. No. 7,152,014 discloses a mobile phone having a sensor for inputting telephone numbers in an imitative mode.

To direct at the computer games, without cooperation of software similar to the Wii at present, no special proprioception operation device has been published. U.S. Pat. No. 7,145,551 discloses a computer joystick having a sensor. In the process of playing a computer game, controlling various angles of an object such as an airplane may be realized by tilting a joystick. As described above, without cooperation of the special game software, besides flying tool games such as airplane games, no other games can be played using the joystick. As far as a computer game, the computer game substantially has to be played using a keyboard. The U.S. Pat. No. 7,239,301 discloses a special application of a mouse. The design is still based on shifting or rotating a mouse or a joystick to cooperate with the rotation of a cursor of a computer system or goals in a game, which cannot provide a universal input mode for most games.

### BRIEF SUMMARY OF THE INVENTION

To direct at the above problems, the invention provides a motion sensing input device of a computer system. When a user plays a computer game by using the motion sensor to replace a keyboard, the user can experience a lifelike game environment and an intuitive operation mode.

The invention discloses a motion sensing input device of a computer system. The motion sensing input device includes a motion sensor and a receiver. The receiver is connected with the computer system. The motion sensor and the receiver are connected with each other in a wireless transmission mode. The motion sensor includes a micro-control unit, a wireless transmitting unit, and two gyroscopes. The motion sensor is used to sense changes of angular velocities around two axes of the motion sensor via the two gyroscopes, respectively, to generate sensed data via the micro-control unit, and to transfer the sensed data to the receiver wirelessly via the wireless transmitting unit. The receiver includes a microprocessor, a wireless receiving unit, and a transmission interface. After the wireless receiving unit receives the sensed data, the microprocessor is used to decode and to convert the sensed data to a corresponding keyboard input signal predetermined by a user. Then the keyboard input signal is transmitted to the computer system via the transmission interface.

Therefore, the two gyroscopes of the motion sensor are used to sense the changes of the angular velocities around the two axes when the user rotates the motion sensor around a rotatable hand joint as a pivot point. The receiver directly decodes the motions, generates the corresponding keyboard input signals, and directly transmits the keyboard input signals to the computer system. Since the receiver is directly used to decode the motions, game software can avoid mis-determining cheating software. Meanwhile, since the motion signals are converted to the keyboard input signals, the user can define different keys on the keyboard to correspond to the motions in different directions, which can be used in different kinds of game software. At the same time, to cooperate with the game software of an action game, more particularly of a sport game, the motion sensing input device can further provide a lifelike game environment and an intuitive operation mode for the user.

These and other features, aspects, and advantages of the present invention will become better understood with regard to the following description, appended claims, and accompanying drawings.

### BRIEF DESCRIPTION OF THE DRAWINGS

FIG. 1 is a schematic diagram of a motion sensing input device of a computer system according to an embodiment of the invention;

FIG. 2A to FIG. 2D are schematic diagrams showing flow paths of decoding motions by a motion sensing input device of a computer system according to an embodiment of the invention; and

FIG. 3 is a schematic diagram showing how a user to operate a motion sensing input device of a computer system according to an embodiment of the invention.

### DETAILED DESCRIPTION OF THE EMBODIMENTS

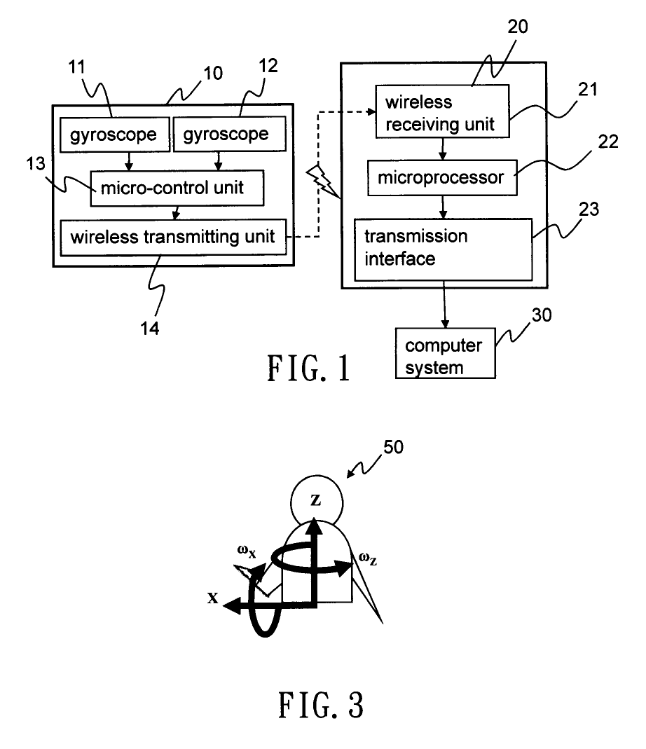

As shown in FIG. 1, a motion sensing input device of a computer system includes a motion sensor 10 and a receiver 20. The receiver 20 is connected with a computer system 30, and the motion sensor 10 is communicationally connected with the receiver 20 in a wireless transmission mode. The motion sensor 10 includes a micro-control unit 13, a wireless transmitting unit 14, and two gyroscopes 11 and 12. Each of the gyroscopes 11 and 12 is a single-axis gyroscope for only sensing one axis, and the gyroscopes 11 and 12 are used to sense a change of an angular velocity around a first axis and that of an angular velocity around a second axis, respectively. Generally speaking, the first axis and the second axis are perpendicular to each other, and they are the two axes on an operating plane of the motion sensor 10. In other words, when a user operates the motion sensor, the first axis and the second axis are the two axes on the plane substantially parallel to the plane of the user's body. That is, they are the two axes around which the user operates the motion sensor 10 to sway up and down and to sway left and right.

The micro-control unit 13 controls the gyroscopes 11 and 12 to sense the changes of the angular velocities around the two axes thus to generate sensed data. The wireless transmitting unit 14 transfers the sensed data to the receiver 20. Generally speaking, the wireless transmitting unit 14 can be used in a radio-frequency transmission mode, an infrared ray transmission mode, or a Bluetooth transmission mode, which are the most common wireless transmission modes. Therefore, the invention does not limit the transmission mode thereto.

The receiver 20 includes a wireless receiving unit 21, a microprocessor 22, and a transmission interface 23. The receiver 20 is communicationally connected with the wireless transmitting unit 14 of the motion sensor 10 via the wireless receiving unit 21 in a wireless mode to receive the sensed data transferred by the wireless transmitting unit 14. The sensed data are directly decoded and converted to a keyboard input signal to which the motion corresponds via the microprocessor 22 in a predetermined mode. Then the keyboard input signal is directly transmitted to the computer system 30 via the transmission interface 23. Preferably, the transmission interface 23 can be a universal serial bus (USB). The invention does not limit the interface thereto.

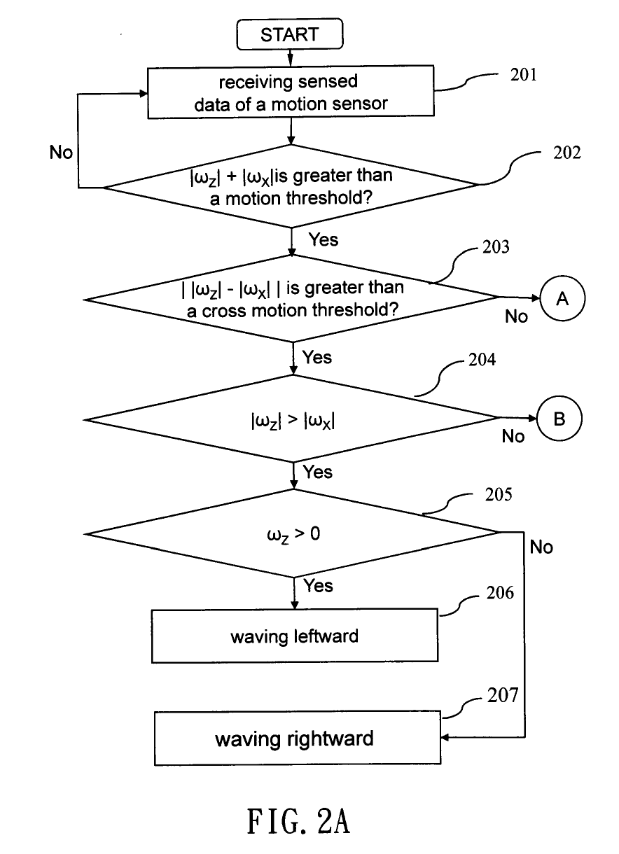

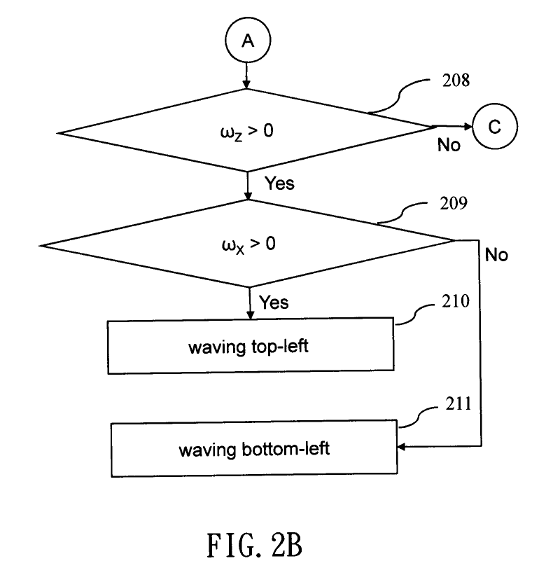

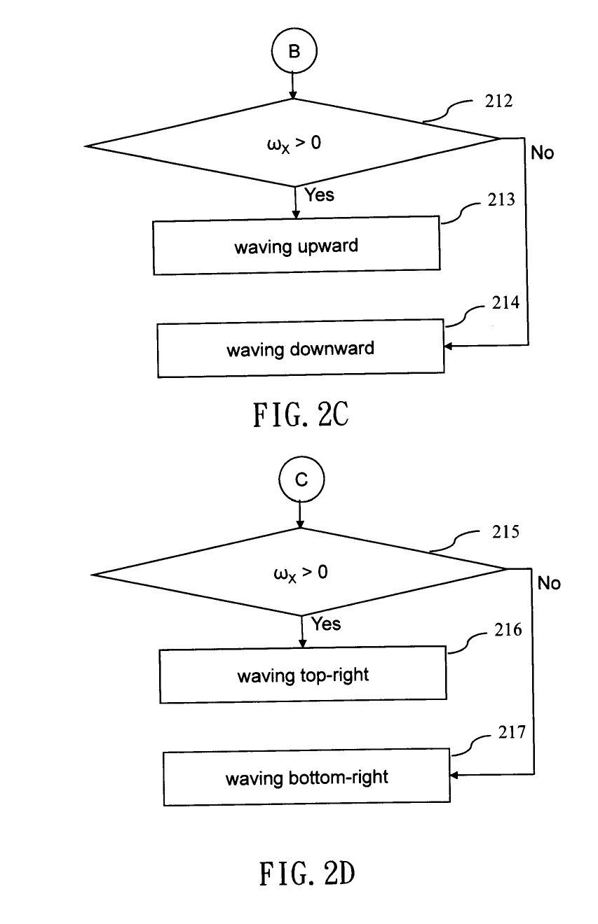

FIG. 2A to FIG. 2D are schematic diagrams showing flow paths of decoding motions by a motion sensing input device of a computer system according to an embodiment of the invention.

First, as shown in FIG. 3 and FIG. 1, an upward direction relative to a user 50 is defined as a Z axis, and a rightward direction relative to the user 50 is defined as an X axis. Assuming that the user is stationary with an initial posture to hold the motion sensor 10 during operation, two axes sensed by the gyroscopes 11 and 12 are superposed upon the X axis and the Z axis, respectively. That is, the gyroscope 11 can sense an angular velocity ωₓ around the X axis, and the gyroscope 12 can sense an angular velocity ω_{z} around the Z axis. Assuming that when the user 50 holds the motion sensor 10 during operation, the user does not make the motion sensor 10 move in a simple straight line but rotate around a rotatable hand joint (such as a wrist or an elbow) as a pivot point. Therefore, the gyroscopes 11 and 12 can sense the corresponding angular velocity, respectively. As far as general operation, the user can wave in eight directions such as wave upward, wave downward, wave leftward, wave rightward, wave top-left, wave bottom-left, wave top-right, and wave bottom-right. Thus, the two gyroscopes 11 and 12 can determine the motions in eight directions, which are described in detail hereinbelow.

First, the receiver 20 receives the sensed data transferred by the motion sensor 10 (step 201). Then, whether |ω_{z}|+|ωₓ| is greater than a motion threshold is determined (step 202). Since casual motions of the user 50 can cause the gyroscopes 11 and 12 to sense and to generate the sensed data, and the casual motions are not the motions which the user really wants to make, determining whether the |ω^{z}|+|ωₓ| is greater than the motion threshold can be used to determine whether the user really wants to make the motion. Besides the above determination mode, whether the ω_{z}| and the |ωₓ| are greater than the motion threshold can be determined, respectively. Once one angular velocity is determined to exceed the motion threshold, the user is determined to really make the motion.

Afterwards, whether ∥ω_{z}|−|ωₓ∥ is greater than a cross motion threshold is determined (step 203). In other words, if the user operates the motion sensor to move along the X axis or the Z axis, one angular velocity in one direction is sure to be greater than the other angular velocity. Therefore, the motions can be determined via the setting of the cross motion threshold. If the ∥ω_{z}|−|ωₓ∥ is greater than the cross motion threshold, the user is determined to rotate the motion sensor around the X axis or the Z axis (in reality, the user waves along the X axis or the Z axis). Then, whether the |ω_{z}| is greater than the |ωₓ| is determined (step 204). According to the above determination, the motion is determined to move along the Z axis or the X axis. Therefore, the greater one of the absolute values of the angular velocities |ω_{z}| and |ωₓ| indicates the direction of the motion. If the absolute value of the ω_{z} is greater, the sign of the angular velocity ω_{z} can determine the direction of the motion. In other words, to cooperate with FIG. 3, if the user waves leftward, that is, to wave around the Z axis, the ω_{z} is a positive value. If the user waves rightward, that is, to wave rightward around the Z axis, the ω_{z} is a negative value. Then, whether the ω_{z} is greater than zero is determined (step 205). If yes, the user is determined to wave leftward (step 206). If no, that is, ω_{z}<0, the user is determined to wave rightward (step 207). In the other aspects, if the absolute value of the ωₓ is larger, referring to FIG. 2C, the user is determined to wave upward or downward along the Z axis. If the user waves upward, that is, to wave around the X axis, the ωₓ is a positive value. If the user waves downward, that is, to wave downward around the X axis, the ωₓ is a negative value. Therefore, whether the ωₓ is larger than zero is determined (step 212). If yes, the user is determined to wave upward (step 213). If no, that is, ωₓ<0, the user is determined to wave downward (step 214).

In another aspect, if the ∥ω_{z}|−|ωₓ∥ is determined to be less than the cross motion threshold, that is, if the angular velocity around the Z axis is equivalent to that around the X axis, the user waves in an oblique direction relative to the X axis and the Z axis. The oblique direction may be one of four directions such as a top-right direction, a down-right direction, a left-up direction, and a left-down direction. As shown in FIG. 2B, first, whether the ω_{z} is greater than zero is determined (step 208). If yes, the ω_{z} is a positive value, and the motion is to wave leftward. In the other words, the motion is to wave left-down or wave left-up. Then whether the ωₓ is greater than zero is determined (step 209). If yes, the user is determined to wave left-up (step 210). If no, that is, ωₓ<0, the user is determined to wave left-down (step 211).

Afterwards, as shown in FIG. 2D, when the ω_{z} is less than zero, the motion is to wave leftward. In the other words, the motion is to wave right-down or to wave right-up. Then whether the ωₓ is greater than zero is determined (step 215). If yes, the user is determined to wave right-up (step 216). If no, that is, ωₓ<0, the user is determined to wave right-down (step 217).

Therefore, according to the aforementioned determination, the eight directions in which the user 50 operates the motion sensor 10 can be confirmed. The motions can be converted to the corresponding keyboard input signals via the microprocessor 22 of the receiver 20, and the signals can be transmitted to the computer system 30. Since the motions are converted to the keyboard input signals, the motion sensor is adapted for different computer games on the computer system 30 at present. For example, in a tennis game, a keyboard is used to control the game. If the user is to play a flat drive in the game, the user needs to press a Z key on the keyboard. If the user is to hit a lob, the user needs to press an X key on the keyboard. If the user is to hit a forceful smash, the user needs to press a C key on the keyboard. Then the motion of waving leftward can be defined to correspond to the Z key on the keyboard. Thus, as long as the user waves leftward, an input signal of the Z key on the keyboard can be transmitted to the computer system 30, and then the flat drive is played in the game. In the same way, the motion of waving upward can be defined to correspond to the X key on the keyboard. Therefore, as long as the user waves upward, an input signal of the X key on the keyboard can be transmitted to the computer system 30, and then the lob is hit in the game. The motion of waving upward can be defined to correspond to the C key on the keyboard. Therefore, as long as the user waves upward, an input signal of the C key on the keyboard can be transmitted to the computer system 30, and then the forceful smash is hit in the game. Thus, the user can use the motion sensing input device of the computer system to play different kinds of computer games. At the same time, the user can experience a lifelike game environment and an intuitive operation mode by the setting of the key signals to which the motions correspond. A plurality of motions can also correspond to a same key on the keyboard. To take an action game as an example, the motions of waving left-down and waving right-down can be set to correspond to an A key on the keyboard, and the A key corresponds to an attack in the game to imitate a direct chopping and killing motion thus to provide proprioception operation for the user. In another aspect, the motions of waving leftward and waving rightward can also be set to correspond to a D key on the keyboard, and the D key corresponds to a defense in the game to imitate a motion of defending with a cutlery thus to provide the lifelike proprioception operation for the user.

In the same way, the other different sports games such as a baseball game or action games using a cutlery to chop and kill can also provide the lifelike proprioception operation via the similar setting. At the same time, as far as general computer games, not many keys are used in the games. Therefore, two gyroscopes for determining the motions in eight directions (in other words, eight keyboard input signals can be set) are used. At the same time, two sets of the motion sensors can cooperate with left and right hands of the user, respectively, to provide 16 keyboard input signals.

In another aspect, to prevent the cheating software in the computer games, at present, the game software can block the programs other than itself. Therefore, in the invention, the receiver is used to decode the motions. The computer system only receives the keyboard input signals, and the computer system does not need additional software or programs to make analysis, which can greatly increase compatibility of the games. Thus, the application can be wider.

Although the present invention has been described in considerable detail with reference to certain preferred embodiments thereof, the disclosure is not for limiting the scope of the invention. Persons having ordinary skills in the art may make various modifications and changes without departing from the scope and spirit of the invention. Therefore, the scope of the appended claims should not be limited to the description of the preferred embodiments described above.

What is claimed is:

1. A motion sensing input device of a computer system, comprising:
a motion sensor, including a micro-control unit, a wireless transmitting unit, and two gyroscopes, for sensing changes of angular velocities around two axes of the motion sensor via the two gyroscopes, respectively, generating sensed data via the micro-control unit, and transferring the sensed data wirelessly via the wireless transmitting unit; and
a receiver, connected with the computer system and including a microprocessor, a wireless receiving unit, and a transmission interface, for receiving the sensed data via the wireless receiving unit, converting the sensed data to a corresponding keyboard input signal via the microprocessor, and transmitting the keyboard input signal to the computer system via the transmission interface.

2. The motion sensing input device of the computer system according to claim 1, wherein each of the gyroscopes is a single-axis gyroscope, and the gyroscopes are used to sense the change of the angular velocity around a first axis and that of the angular velocity around a second axis, respectively.

3. The motion sensing input device of the computer system according to claim 2, wherein the gyroscopes are used to sense the change of the angular velocity around the first axis and that of the angular velocity around the second axis, respectively, when a user operates the motion sensor with a hand rotation joint as a pivot point.

4. The motion sensing input device of the computer system according to claim 3, wherein the gyroscopes are used to sense motions in eight directions when the user operates the motion sensor.

5. The motion sensing input device of the computer system according to claim 4, wherein if the absolute value of the difference between the change of the angular velocity around the first axis and that of the angular velocity around the second axis is less than a cross threshold value, the motion sensor is determined to move along the first axis or the second axis.

6. The motion sensing input device of the computer system according to claim 4, wherein if the absolute value of the difference between the change of the angular velocity around the first axis and that of the angular velocity around the second axis is greater than a cross threshold value, the motion sensor is determined to move in an oblique direction relative to the first axis or the second axis.

7. The motion sensing input device of the computer system according to claim 1, wherein the wireless transmitting unit can be used in a radio-frequency transmission mode, an infrared ray transmission mode, or a bluetooth transmission mode.

8. The motion sensing input device of the computer system according to claim 1, wherein the keyboard input signal converted by the microprocessor is set by a user.

9. The motion sensing input device of the computer system according to claim 1, wherein the transmission interface of the receiver is a universal serial bus (USB).
